(19) United States
(12) Patent Application Publication
(10) Pub. No.: US 2026/0268062 A1
(43) Pub. Date: Sep. 10, 2026

(54) Generative AI Pipeline for Extracting Insights from Unstructured Creative Data and Tagging and Categorizing Same

(71) Applicant: Unity Technologies SF, San Francisco, CA (US)

(72) Inventors: Xiaowen Ma, Toronto (CA); Corey Cohen, San Francisco, CA (US)

(21) Appl. No.: 19/074,071

(22) Filed: Mar. 7, 2025

(51) Int. Cl. G06F 40/12; G06F 40/40

(52) U.S. Cl. CPC G06F 40/12; G06F 40/40

(57) ABSTRACT

A method might comprise obtaining a multimedia content object, determining a set of prompts for input into a trained ML model, the set of prompts configured to result in the trained ML model generating an output data targeted structure, combining the set of prompts into a singular prompt data object, and applying the singular prompt data object and the multimedia content object to the trained ML model to generate, as an output of the trained ML model, an output data object according to the output data targeted structure. Content might be extracted from a content object using a multimodal large language model by receiving an unstructured multimedia content input comprising the content object, and processing the content object using a single natural language prompt, the single natural language prompt providing, to the multimodal large language model, instructions for extracting human-readable and/or machine-processable structured information from the content object.

### FIELD

The present disclosure generally relates to processing content to extract insight data and more particularly to processing video, image, and other created content using an AI pipeline to derive insight data about the created content to form tagging data or other data structures related to the created content.

### BACKGROUND

Online content is created at an astounding rate. For platforms that host the online content, they might need or want to extract information from unstructured content such as the nature of content stored as an electronic content object, tagging the content, and categorizing it. For example, where a computer network connects publishers of content and advertisers with their advertising content for presentation to viewers, there might be a large number of advertising content objects that might be vetted to determine whether the advertising content is appropriate for the published content it is paired with, content is moderated and compliant with requirements that the network might have. Manual tagging and categorizing can be costly and differences among human taggers, such as cultural differences, might leave to differing interpretations and inconsistencies.

An automated review system might be used to consider a content object for tagging, categorizing, deduplicating (e.g., noting when multiple content objects are essentially the same thing to the ultimate consumer, such as two advertising content objects that generate more or less the same advertising presentation), visual search to identify elements of a presentation encoded in the content object, and other automated content analysis tasks. An automated review system using a supervised learning model requires historical data, posing a problem when a new content object comes to the automated review system that it has never seen before and therefore cannot provide any immediate insight on. While embeddings can help to solve this problem, their potential may be limited when compared to the direct consumption of creative labels for model training. Large object sizes, such as high-resolution images, videos, etc. can require significant pre-processing in order to compress them into a smaller size and be put into downstream models. This presents numerous opportunities for loss of previously preserved data.

In light of these issues, improvements for generative AI pipelines might be desired.

### SUMMARY

A computer-implemented method for processing data with trained ML model might comprise obtaining a multimedia content object, determining a set of prompts for input into the trained ML model, the set of prompts configured to result in the trained ML model generating an output data targeted structure, combining the set of prompts into a singular prompt data object, and applying the singular prompt data object and the multimedia content object to the trained ML model to generate, as an output of the trained ML model, an output data object according to the output data targeted structure.

The set of prompts might comprise a data structure operated upon as a single prompt. The data structure might include indications of the output data targeted structure, and wherein the indications indicate that the output data targeted structure should include specific field names, specific data types, specific default values, specific formats, and/or a description of expected content as specified by the indications. The data structure might include guidance elements to indicate directions and/or constraints on the output data targeted structure.

The set of prompts might comprise a data structure operated upon as a single prompt that provides an indication of an output schema structure. The multimedia content object might comprise one or more of text, an image, audio, an animated banner, and/or an interactive webpage. The multimedia content object might represent an advertisement. The multimedia content object might be specified by a URL. The set of prompts might include a product name prompt, a product type prompt, a genre prompt, and a visual summary prompt.

The singular prompt data object might be formatted as a JSON string. The singular prompt data object might be formatted in some human-readable form.

Extracting content from a content object using a multimodal large language model might be done by receiving an unstructured multimedia content input comprising the content object, and processing the content object using a single natural language prompt, the single natural language prompt providing, to the multimodal large language model, instructions for extracting structured information from the content object, wherein the structured information is both human-readable and machine-processable.

The single natural language prompt might represent a semantic context of the unstructured multimedia content input. The content might be video content. The multimodal large language model might be a model that processes visual content, audio content, and/or textual content. The single natural language prompt might include indications of the structured information, and the indications might indicate that the structured information should include specific field names, specific data types, specific default values, specific formats, and/or a description of expected content as specified by the indications. The indications might include guidance elements to indicate directions and/or constraints on the structured information.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of methods and apparatus, as defined in the claims, is provided in the following written description of various embodiments of the disclosure and illustrated in the accompanying drawings.

### BRIEF DESCRIPTION OF THE DRAWINGS

Various embodiments in accordance with the present disclosure will be described with reference to the drawings, in which:

FIG. 1 is a block diagram of a pipeline system according to embodiments.

FIG. 2 is a block diagram of a variation using a video content server.

FIG. 3 is a block diagram of a video tagging arrangement.

FIG. 4 illustrates an example of frame grabs of a video stored in a video storage.

FIG. 5 illustrates an example computer system memory structure as might be used in performing methods described herein, according to various embodiments.

FIG. 6 is a block diagram illustrating an example computer system upon which the systems illustrated in FIGS. 1 and 5 may be implemented, according to various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

An automated generative AI pipeline can extract insights from unstructured creative objects and app-level data. Unstructured creative objects might include content that is textual, visual, audio, etc. and might contain or include app content. Unstructured creative objects might be content that is for an advertisement and might be referred to as an “ad creative” object. In many examples herein, the unstructured creative objects are used for advertising and thus might be referred to as “ad creative objects” or “ad creatives” for short. Upon reading this disclosure, it should be apparent how the methods and apparatus here can be used in other fields as well.

The automated generative AI pipeline might generate outputs that are insights into the content and might be included with the content for ingestion by downstream systems. For example, the automated generative AI pipeline might automatically review and characterize video content. Performance of an automated generative AI pipeline might be measured, and the measurement might include metrics such as percentage of video objects having an auto-tagged label, average time-to-review for video objects, cost to review per video object, percentage of labels used in training or enforcement, percentage of objects having an associated complaint, etc.

Where the automated generative AI pipeline is used for moderation and where a moderation system might block content objects and handle appeals of blocking, the measurement might include metrics such as percentage of restricted video objects across all moderated video objects, percentage of rejected video objects across all moderated video objects, false positive rate of labels, overall accuracy of labels, percentage of objects having an associated appeal, percentage of objects having an associated complaint, and/or similar metrics.

The performance metrics referred to above can be important for efficiently managing a content network such as an ad network. For example, if an advertising object is tagged as having a certain characteristic that would block it from being used (e.g., a monster truck ad might be blocked from being paired with a video game or app that is targeted at children or an ad for a real-money gaming app being paired with content that is being presented in jurisdictions where such gaming is prohibited) but that advertising object does actually have that certain characteristic, the advertiser might appeal the designations. On the other end of the scale, viewers might complain when inappropriate advertising gets paired with certain content based on incorrectly assigned characteristics.

There are many downstream uses of automated tagging, such as filtering, pairing, distribution, etc. Some tags might be used for automated moderation, automated compliance handling, age ratings, etc. A provider of such creative objects might want a mechanism for flagging incorrect tags and that might be used to improve the automated generative AI pipeline. Post-processing data scientists might want the tagged content to be in a form that is easily processed by querying engines, and it might be desirable to have a finite volume of distinct labels so that they can be leveraged as a trainable embedding.

In some specific embodiments, there might be a defined set of creative labels, a service architecture and pipeline, automated determination and creation of a real-money gambling label set and a real-world reward label set, with manual validation of a model output on a label set. Outputs of an auto-tagging validation pipeline might be validated against existing manual pipeline reviews.

In some embodiments, a campaign processing system can consume internal/external features and iteratively produce data sets such as theorem creative attribute labels, expanded creative content attribute labels, app category labels with creative content, creative sentiment labels (e.g., annoyingness, addictiveness, etc.), etc.

The automated generative AI pipeline can improve efficiency, accuracy, and scalability of an ad review process by automating the video understanding and characterization without the need for human viewing. The output can be structured data with adjustable labels and properties and the input objects can be unstructured content.

In some embodiments, automated generative AI pipeline uses multi-modal large language models for video understanding, enforced structure of outputs for easy consumption of any downstream tasks, and/or multi-step prompting with feedback.

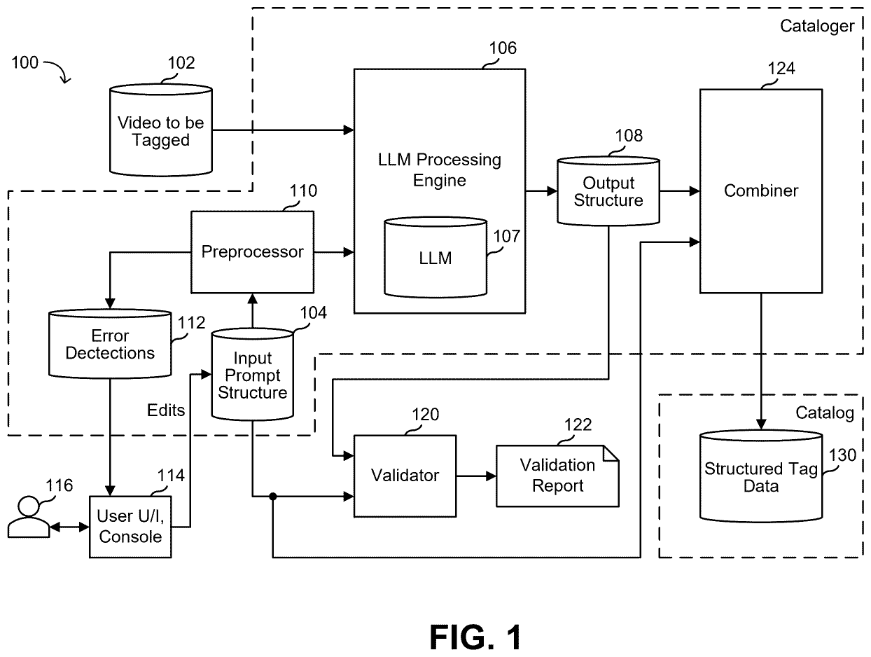

FIG. 1 is a block diagram of a pipeline system 100 according to embodiments. As shown there, a video 102 to be tagged is provided to an LLM processing engine 106 having an LLM 107 that in turn outputs an output structure 108. An input prompt structure 104, which might have a structure similar to output structure 108, can be edited as shown by a user 116 using a user interface 114. Input prompt structure 104 can be provided to a pre-processor server 110 before being provided to LLM processing engine 106. Where preprocessor 110 identifies errors in the structure of input prompt structure 104, it can feed those to an error detections storage 112, which can then present the errors detected to user 116 on user interface 114 to allow user 116 to further edit input prompt structure 104 accordingly.

A validator 120 might compare input prompt structure 104 and output structure 108 to a validation report 122 indicating whether there are inconsistencies in the structures. Input prompt structure 104 and output structure 108 can be provided to a combiner 124 that combines those into a structure tagged object that can then be stored in structure tagged data store 130.

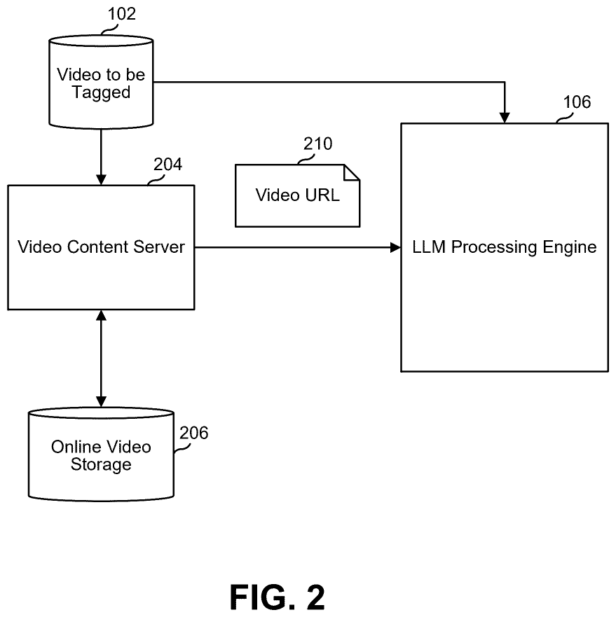

FIG. 2 is a block diagram of a variation using a video content server. In that variation, video 102 is stored by a video content server 204 into an online video storage 206. Video 102 can be provided to LLM processing engine 106, but alternatively video content server 204 can provide video URL 210 to LLM processing engine 106, which can then retrieve the video, using video URL 210, from online video storage 206.

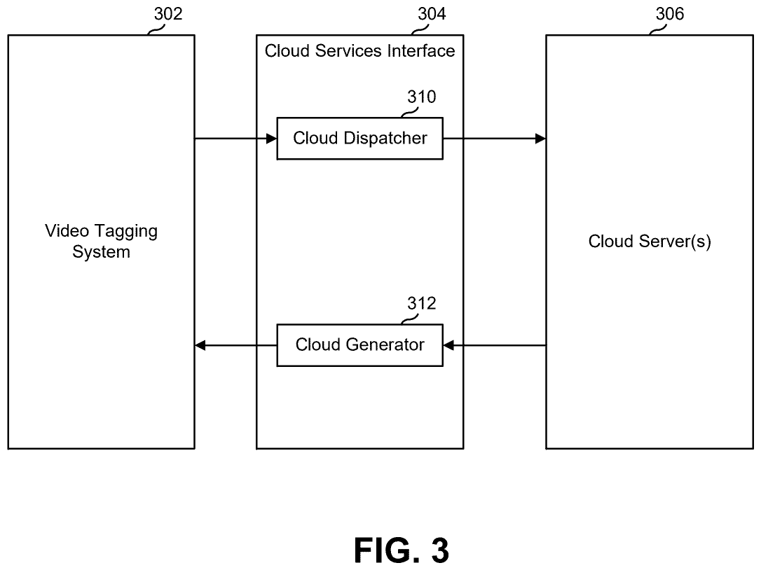

FIG. 3 is a block diagram of a video tagging arrangement. As shown there, a video tagging system 302, which might comprise some of the elements shown in FIG. 1 and/or FIG. 2, sends objects to a cloud server 306 via a cloud dispatcher 310 of a cloud services interface 304. Video tagging system 302 can also receive objects from cloud server 306 through a cloud generator 312 of cloud services interface 306.

Using the methods described herein, an automated generative AI pipeline can take as inputs (a) some unstructured video and (b) structured prompts, apply that to a model, and output a data structure with label(s) and/or tag(s) characterizing the input video. The output data structure might have a structure as instructed by the structured prompts, which might be related to a structure of the input prompts.

In this manner, an efficiency optimization method might be provided for multimodal LLM usage speed-up and cost reduction, while retaining the quality of outputting consistent with large, structured data. The speed-up and cost reduction might be achieved by first converting a multi-prompt or multi-agent workflow to a single-prompt input and applying that single-prompt input to an LLM. The single-prompt input to the LLM might be a schema that is descriptive, ordered, and has an enforced schema structure. The single-prompt input to the LLM might contain a full schema in that it matches the expected output of the LLM. In some exemplary implementations, the full schema might comprise several fields, perhaps 2, 5, 10, 40, or more. The schema might specify types for each field and might include nested fields. The format for the single-prompt input (and the LLM output) might be JSON or YAML. The schema might also include descriptions of what information is required in each (or at least some) of the fields.

The output JSON might be structured to have fields ordered as given in the schema. This can take advantage of the way an LLM generates texts by always ensuring the required context field is already generated before the decision fields are. Some example context fields might include fields that specify a content's context, such as “visual summary,” “speech summary,” and/or “captions summary”. These fields could describe different aspects of content and might be used by a moderation system or other system that needs to determine what is in the content. From the content, and possibly also the context fields, a tagging system might generate and attach decision fields such as “game genre,” “fraud probability metric”, “production quality score”, etc. Some of these fields might be used as moderation tags that a moderation system would use to decide what to do with the content without the moderation system having to fully process the content on its own.

The set of prompts for input to a trained ML model, such as an LLM, might comprise a data structure that is organized as a single prompt. The prompt (or prompts) might include a full specification of a targeted output, such as a targeted output having specific field names, data types, default values, formats (e.g., strings, numbers), description of expected content, potential units used in numerical fields, among other elements. The prompt (or prompts) might include a predefined collection of allowed text strings for categorical fields, consistent and normalized scales for score/probability/rating fields (e.g., “field F123 should be an integer ranging from 0 to 100). The prompt (or prompts) might also include guidance elements, such as an element indicating how strongly the trained ML model should weight preserving an ordering of fields in the output, elements providing examples for fields that have concrete definitions or fields that are ambiguous, elements providing positive examples for indicating what to look out for and negative examples for avoiding false positives. The prompt (or prompts) might also include guidance for which key fields to emphasize in decision making.

The prompt (or prompts) might include an indication of a preferred output text format (e.g., JSON, text, XML, etc.). The prompt (or prompts) might include directions for placing an ordering of fields, such as ordering descriptor fields (e.g., visual descriptions, audio descriptions, etc.) before decision fields (e.g., moderation tags).

Prior to supplying the single-prompt input to the LLM, a validator might check the proposed single-prompt input to ensure it complies with the schema, as shown in FIG. 1, in terms of typing and parsing, and if it does not, the validator might ask an input-generating component to fix it so that single-prompt input complies with the schema and noncompliant inputs do not get input to the LLM. The parsing might include identifying missing fields. In some embodiments, missing fields and/or content of those missing fields are checked and added as part of the validation process or part of some pre-process or post-process.

Outside of the LLM that might be processing a video to generate the structured LLM output, a system might have an aspect extractor that extracts video aspects. Examples of video aspects include visual summary, style, genre, speech transcription, music description, sound effects, captioning, text OCR, sentiment description, toxicity measurements, landmark detection, famous person recognition, moderation considerations, etc. These “context” fields are generated first in the output so that the “decision making” fields such as “content tags”, “fraud probability”, “production value” and various scores can reference the just-generated descriptions as the output is still being generated for the single-prompt. Content tags might be used by a moderation system to make decisions about the content. In this way, earlier output words or tokens might influence the later output of output words or tokens. For example, a content tag might tag some content that might be an advertisement and tag it with a particular brand, category, or advertiser and then if the moderation system were tasked with flagging, filtering, or routing that content based on what it contains, the moderation system could read the context tags and apply applicable rules to the content.

The single-prompt input might be parsed dynamically at inference time, so it can include sections/fields that non-programming developers can add or modify to alter the behavior of the LLM by providing it patterns to look for. For example, a section might be represented as text in a YAML/JSON prompt template that provides definitions of specific terms, such as defining the term “real money gambling” as “content that appears to show a casino-like operation and also includes a payment app.” With such a definition, a moderation system that is tasked with blocking real money gambling need only look for a “real money gambling” tag. Because the section is represented in plain text, a user or another computer process can identify the term and its definition and modify it as well. For example, a reviewer (human or not) might determine that “content that appears to show a casino-like operation and also includes a payment app” is not a good definition and might change it to “content that has at least one visual component that matches a gambling game visual and where the content also includes links or references to a payment app that could pay out winnings to a player.” Another example might be that the term “real money gambling” means “content containing one or more of the keywords {“casino”, “jackpot”, “slot machine”}.” Using this approach, even non-developers can understand how a moderation system is going to process certain content and they can easily adjust the definitions so that the moderation system operates differently.

The developer-editable fields might include specifiers (e.g., client/product specific “red-flags” or “black-lists”) that vary based on the type of input video.

A YAML/JSON prompt template might provide a JSON string such as:
‘{“product_name”: “example_game_title”, “product_type”: “game”, “genres”: [“puzzle”, “casual”], “visual_summary”: “example visual summary”, . . . }’
   A simplified example prompt might be ‘provide a JSON string with fields defined below extracting information from the given video: product_name: name of the advertised game or app, product_type: choose among “game”, “app”, “website”, or “other”, visual_summary: . . . ’.

The structured output might also include details of intervening human decision-making about an object and any downstream task that intends to take advantage of the embeddings can train models on top of it in order to output actionable decision-making insights.

In another example, an ad that displays casino games, such as slot machines with spinning reels and emphasizes the chance to win real cash prizes, would be flagged as a “real money gambling” ad. Likewise ads that feature live dealer games, such as poker with real-time interaction and the opportunity to win actual money, ads that promote sports betting with live odds and the ability to place real money bets on sports events, ads that offer bonuses such as free spins or deposit matches that directly contribute to real-money gameplay, ads that highlight poker tournaments where players can compete for real cash prizes and winnings, credit message notifications, ad that display credit card, bank, payment app names/logos, ads that show gambling games with deceptive pop-up, notification, update, warning, error, or imitations of banking apps with balance amounts, and the like would also be flagged as a “real money gambling” ads.

### Cataloger, Catalog, Console

A cataloger might provide a backend pipeline that acquires data from sources and pushes it through the necessary processing for cataloging. The cataloger is responsible for ingress of raw creative videos and metadata, prompting and interaction with LLMs, and post-processing for generating structured output that is stored into the catalog. The LLM system might be self-hosted or use third-party LLM API services. The cataloger might be implemented with the elements 104, 106, 108, 110, 112, and 124 as shown in FIG. 1.

A catalog might be a database for processed data. This might be a BigQuery table where each record corresponds to a creative object video (or pack of videos) and its columns containing the contextual information output. The choice of such a collection of contextual column fields might depend on what downstream tasks this table is going to be used for. For example, for moderation purposes, there could be fields acting as indicators for inappropriate content, gambling, fraud, violence, usage of trademark/payment logos, IP infringement, etc. for direct GO/NO-GO decision making. Another example would be direct feature import for the valuation model training so that, instead of a highly dimensional embedding vector, simple features like genres can be directly used for model training. The catalog might be implemented as structure tagged data store 130 as shown in FIG. 1.

A console might be a frontend API/SDK/UI for querying/interacting with the catalog for downstream tasks. Examples might be user U/I 114 and structure tagged data store 130 as shown in FIG. 1. A front-facing UI/API console might be used for either power users or beginners. An API like interface could also remove burdens of development and maintenance of querying and data ETL pipelines.

An app index might be generated for some content. Such app/game-level context might be used for the derivation of even more useful insights when combined with visual and audio data. For example, a system might actively check if the content of the creative truthfully reflects what is described in a store page of an app and derive an indicator for that. Other information extracted for an app might be store page descriptions, screenshots, trailer videos, in-app purchase items and their prices, ratings, reviews, retention, store ranking, publisher info, etc.

### Example Use Cases

Real-Money Gambling Creative Detection: The engine (e.g., processing engine 106) can predict whether some content object is an app for, or an ad for, real-money gambling (RMG), and perhaps even what type of RMG is present (e.g., RMG with cards vs. RMG with slots). This can be used for selective blocking, such as where a publisher would like to present an ad paired with their content and may only be interested in blocking some subset of RMG content.
Automated Creative Moderation: Because human review is costly, it can result in limited manual creative review coverage throughout networks. With processing engine 106, for example, moderation might be automated and might provide for a reduction in manual creative review efforts.
Training Data Enrichment for Demand Performance Teams: Creative data can be used as labels for model training or as embeddings for enhanced predictions. This training data can be an output of processing engine 106.
Cold Start Mitigation: Processing engine 106 can lower the dependence on historical data to allow for rapid initial creative exploration when making predictions. While historical data might be used in assessing quality of advertising, user affinity, etc., that is often done without data about the actual ad objects content. Using approaches described herein, characteristics of, say, an ads video is summarized in text/label form, which can be used for valuation model training, with or without available historical data.
Validation Flow: Existing moderation data can be used to verify quality of generated data. Strong agreement in the generated insights relative to existing moderation decision helps gain confidence in the engine's performance, and disagreements cast light on what the weaknesses are for the LLM's video understanding (or that of the moderator), so that iterative improvements can be made.

Using the methods and apparatus described herein, input prompts can be created that can be structured to efficiently convert unstructured data into structured data that is both human readable and machine processable. A single input prompt might be sufficient. This can be more useful than vector embedding, which is typically not human readable and not directly queryable, and more useful than simple classification, which might use single use labels and not be generalizable.

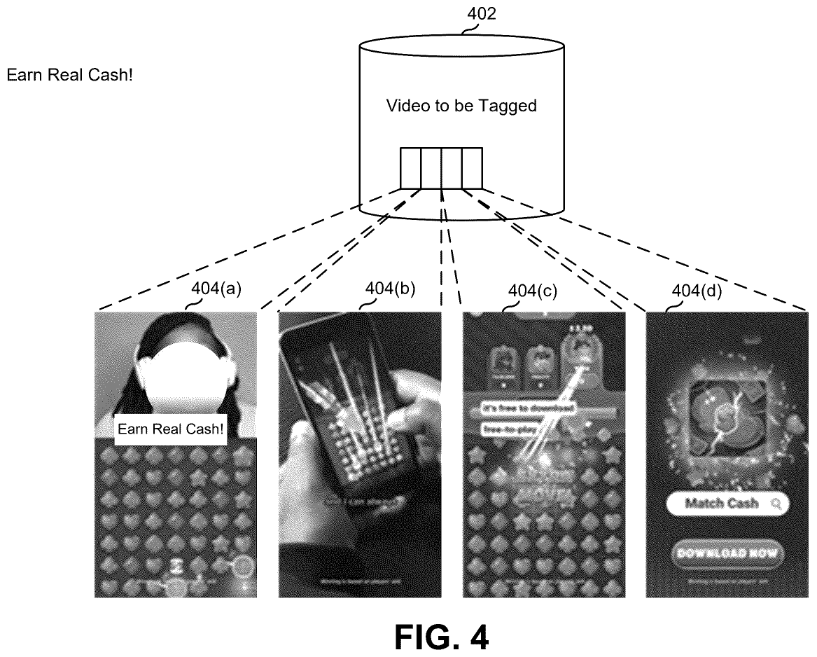

An example of the structured output in JSON format might be as shown in Table 1 below. In that example, an input might be a screenshot or video comprising ad object content as shown in FIG. 4 that results in the output shown in Table 1. FIG. 4 illustrates an example of frame grabs 404 of a video stored in a video storage 402. While illustrated here in monochrome, color screen grabs might be used. These screen grabs might suggest that the game being advertised is used for real-money gambling. In Table 1, some of the values are indicated by “*” or text enclosed in <>, which represent redacted values and/or placeholder names not required for understanding how the methods and apparatus described herein operate.

```
TABLE 1
{
  ”creative_id”: ”*b4ebe”,
  ”campaign_id”: ”*”,
  ”campaign_type”: null,
  ”platform”: ”ios”,
  ”campaign_game_id”: ”*”,
  ”campaign_store_id”: ”*”,
  ”campaign_set_id”: ””*””,
  ”name”: ”sample_creative_1080x1920.mp4”,
  ”game_name”: ”*”,
  ”game_id”: ”*”,
  ”store_id”: ”*”,
  ”store”: ”apple”,
  ”url”: ”https://*.com/*/*.mp4”,
  ”orientation”: ”portrait”,
  ”codec”: ”H264”,
  ”status”: ”processed”,
  ”language”: ”en”,
  ”moderation”: ”*”,
  ”age_rating”: null,
  ”update_time”: ”2024-12-23 15:46:16.834000 UTC”,
  ”run_time”: ”2024-12-23 16:30:00.000000 UTC”,
  ”duration”: ”26.388”,
  ”cpack_ids”: [”*”],
  ”product_name”: ”<Match_Game_name>”,
  ”product_type”: ”game”,
  ”visual_summary”: ”The ad features two individuals having a
    conversation about a mobile match-three game called
    <Match_Game_name>. The woman claims she makes real money playing the
    game, shows a withdrawal screen with a $9 balance, and highlights
    that it is free to play without ads. The man seems interested in
    trying out the game.”,
  ”speech_summary”: ”Have you played <Match_Game_name> yet?
    <Match_Game_name>? What's that? It's an amazing match-three video
    game where you can earn real cash while having fun at the same time.
    It's one of my new side hustles, and I can cash out easily to my
    <Payment_Company_Name>. Oh, wow! That sounds pretty cool, and I can
    always use some extra cash. It really is. Plus, it's free to
    download, free to play, and it has no ads. I definitely got to check
    that out. Just download the <Match_Game_name> app and see for
    yourself.”,
  ”speech_summary_english”: ”Have you played <Match_Game_name> yet?
    <Match_Game_name>? What's that? It's an amazing match-three video
    game where you can earn real cash while having fun at the same time.
    It's one of my new side hustles, and I can cash out easily to my
    PayPal. Oh, wow! That sounds pretty cool, and I can always use some
    extra cash. It really is. Plus, it's free to download, free to play,
    and it has no ads. I definitely got to check that out. Just download
    the <Match_Game_name> app and see for yourself.”,
  ”speech_language”: ”English”,
  ”text_language”: ”English”,
  ”captions”: ”['Have you played <Match_Game_name> yet?',
    ’<Match_Game_name>?’, \”It's an amazing match three video game where
    you can earn real cash while having fun at the same time\”, ’side
    hustles’, ’and I can cash out easily to my PayPal’, ’WITHDRAWAL’,
    ’Submit Request’, ’Upon initiating a withdrawal, all remaining bonus
    cash will be forfeited. Are you sure?’, ’Account balance $9.4’,
    ’Withdrawable amount $9’, ’Withdrawal in progress’, ’You received
    $10.00 USD from <Match_Game_name>’, ’That sounds pretty cool and I
    can always use some extra cash’, \”It really is. Plus it's free to
    download free-to-play and it has no ads\”, ’I definitely got to
    check that out’, ’Just download the <Match_Game_name> app and see
    for yourself’, ’DOWNLOAD NOW’, \”Winning is based on players’
    skill\”]”,
  ”is_subtitled”: ”true”,
  ”bgm_genre”: [”Electronic”],
  ”bgm_name”: null,
  ”sound_effects”: [”Game sound effects”],
  ”genres”: [”Match 3”, ”Puzzle”],
  ”visual_style”: [”2D”, ”Colorful”],
  ”mechanisms”: [”Match-Three”],
  ”trademarks”: [”<Payment_Company_Name>”],
  ”shows_usage”: ”true”,
  ”moderation_tags”: [”real world reward”],
  ”moderation_confidence”: ”100”,
  ”production_value”: ”50”,
  ”engagement_score”: ”60”,
  ”clarity_score”: ”80”,
  ”audio_quality”: ”70”,
  ”addictiveness”: ”70”,
  ”vulgarness”: ”10”,
  ”fraud_prob”: ”60”,
  ”real_money_gambling_prob”: ”80”,
  ”iap_prob”: ”90”,
  ”iap_payment_types”: [”<Payment_Company_Name>”],
  ”annoyingnesses”: [”Repetitive gameplay shown”, ”Exaggerated
    reactions from actors”],
  ”suggestions”: ”Show more diverse gameplay and potentially a loss to
    manage expectations. Tone down the acting and consider adding a
    voice-over for a more professional feel.”,
  ”target_age_group”: [”young adults (18-25)”, ”adults (25-40)”],
  ”target_audience”: [”Casual gamers”, ”People looking for side
    hustles”, ”Mobile gamers”],
  ”target_placement”: [”Social media feeds”, ”Free-to-play mobile
    games”],
  ”click_prob”: ”60”,
  ”prompt_token_count”: ”*”,
  ”candidates_token_count”; ”*”,
  ”error”: null,
  ”ts”: ”2024-12-23 17:12:4.973094 UTC”,
  ”done”: ”true”
}
```

A prompt for a cataloger with the video in video storage 402 of FIG. 4 might be “Given this video ad, extract the following information and provide a JSON formatted string with the schema described below.” The field “moderation_tags” might then be used to indicate how well users are protected from harmful content. In some embodiments, tagging might be conservative and lean towards marking content has potentially harmful. An example schema for the expected output JSON string might be as shown in Table 2.

TABLE 2

| | |
|---|---|
| - | “product_name” (string): the name of the product (e.g., game or app) |
| | being advertised |
| - | “product_type” (string): choose among “game”, “app”, “website”, and |
| | “other” for the product being advertised |
| - | “visual_summary” (string): a three-sentence summary describing the |
| | content of the video |

Note that while many examples herein describe ad objects has having video content, that need not be the case. Ad objects might comprise text, images, audio, animated banners, interactive webpages, and/or other multimedia content.

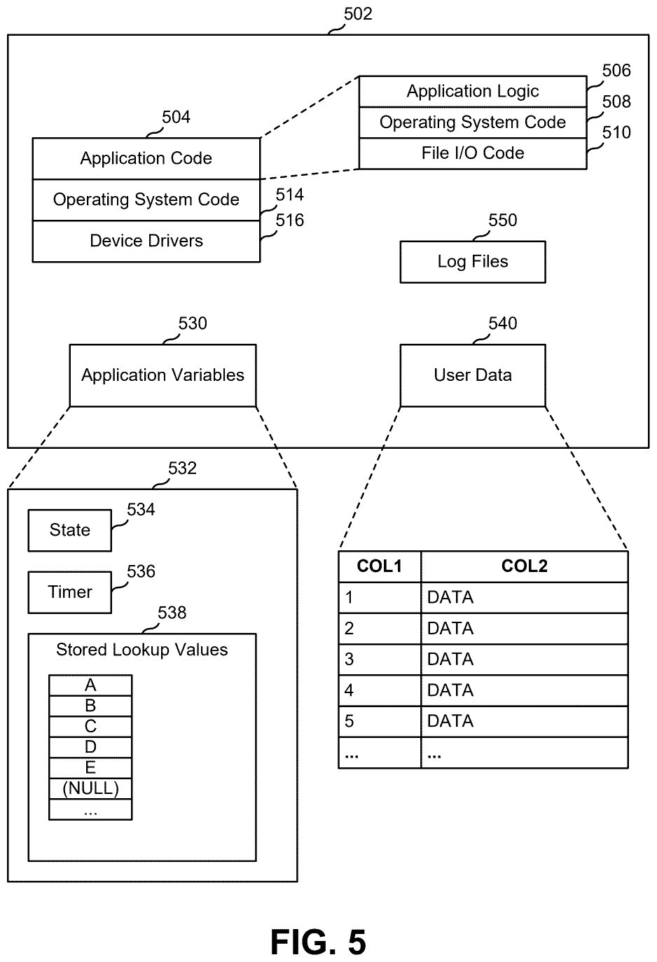

FIG. 5 is a simplified functional block diagram of a storage device 502 having an application that can be accessed and executed by a processor in a computer system as might be part of embodiments of the systems described herein and/or a computer system that performs the methods described herein. FIG. 5 also illustrates an example of memory elements that might be used by a processor to implement elements of the embodiments described herein. In some embodiments, the data structures are used by various components and tools, some of which are described in more detail herein. The data structures and program code used to operate on the data structures may be provided and/or carried by a transitory computer readable medium, e.g., a transmission medium such as in the form of a signal transmitted over a network. For example, where a functional block is referenced, it might be implemented as program code stored in memory. The application can be one or more of the applications described herein, running on servers, clients or other platforms or devices and might represent memory of one of the clients and/or servers illustrated elsewhere.

Storage device 502 can be one or more memory device that can be accessed by a processor and storage device 502 can have stored thereon application code 504 that can be one or more processor readable instructions, in the form of write-only memory and/or writable memory. Application code 504 can include application logic 506, library functions 508, and file I/O functions code 510 associated with the application. The memory elements of FIG. 5 might be used for a server or computer that interfaces with a user, generates data, and/or manages other aspects of a process described herein. In addition to application code 504, storage device 502 might also contain operating system code 514 and device drivers 516.

Storage device 502 can also include storage for application variables 530 that can include one or more storage locations configured to receive variables 532. Application variables 530 can include variables that are generated by the application or otherwise local to the application, such as state variables 534, timers 536, and/or stored lookup values 538. Application variables 530 can be generated, for example, from data retrieved from an external source, such as a user or an external device or application. A processor can execute application code 504 to generate application variables 530 provided to storage device 502. Application variables 530 might include operational details needed to perform the functions described herein.

Storage device 502 can include storage for databases and other data described herein. One or more memory locations can be configured to store user data 540, which might include data sourced by an external source, such as a user or an external device. User data 540 can include, for example, records being passed between servers prior to being transmitted or after being received. Other data might also be supplied.

Storage device 502 can also include log files 550 having one or more storage locations configured to store results of the application or inputs provided to the application. For example, log files 550 can be configured to store a history of actions, alerts, error messages, and the like.

According to some embodiments, the techniques described herein are implemented by one or more generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

One embodiment might include a carrier medium carrying data that includes data having been processed by the methods described herein. The carrier medium can comprise any medium suitable for carrying the data, including a storage medium, e.g., solid-state memory, an optical disk or a magnetic disk, or a transient medium, e.g., a signal carrying the data such as a signal transmitted over a network, a digital signal, a radio frequency signal, an acoustic signal, an optical signal or an electrical signal.

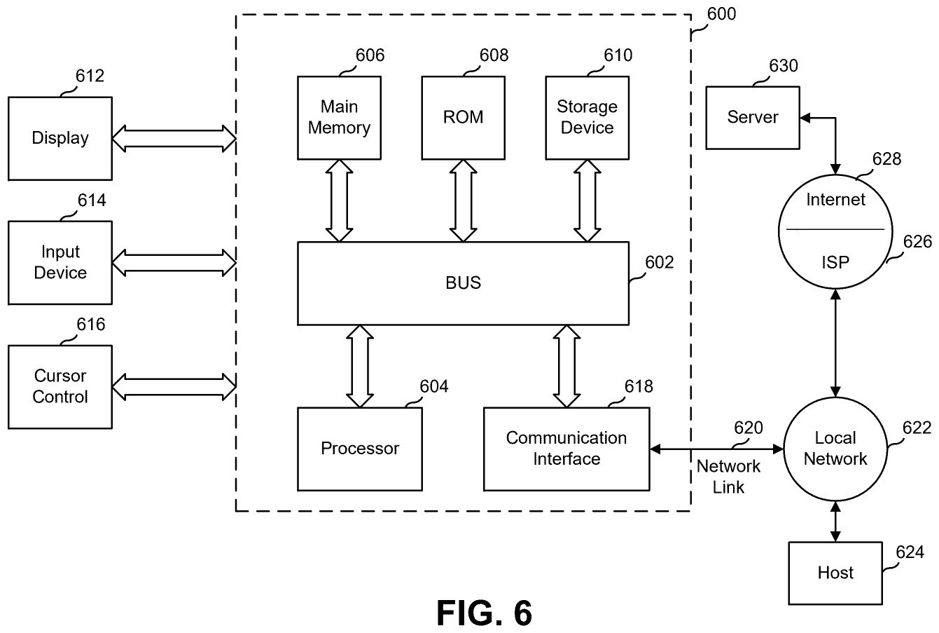

FIG. 6 is a block diagram that illustrates a computer system 600 upon which the computer systems of the systems described herein and/or data structures shown in FIG. 5 may be implemented. Computer system 600 includes a bus 602 or other communication mechanism for communicating information, and a processor 604 coupled with bus 602 for processing information. Processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 may also be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a computer monitor, for displaying information to a computer user. An input device 614, including alphanumeric and other keys, is coupled to bus 602 for communicating information and command selections to processor 604. Another type of user input device is a cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may include non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that include bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a network connection. A modem or network interface local to computer system 600 can receive the data. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be a network card, a modem, a cable modem, or a satellite modem to provide a data communication connection to a corresponding type of telephone line or communications line. Wireless links may also be implemented. In any such implementation, communication interface 618 sends and receives electrical, electromagnetic, or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world-wide packet data communication network now commonly referred to as the “Internet” 628. Local network 622 and Internet 628 both use electrical, electromagnetic, or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620, and communication interface 618. In the Internet example, a server 630 might transmit a requested code for an application program through the Internet 628, ISP 626, local network 622, and communication interface 618. The received code may be executed by processor 604 as it is received, and/or stored in storage device 610, or other non-volatile storage for later execution.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The code may also be provided carried by a transitory computer readable medium e.g., a transmission medium such as in the form of a signal transmitted over a network.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method for processing data comprising:
under control of one or more computer systems configured with executable instructions:
(a) obtaining a multimedia content object;
(b) determining a set of prompts for input into a trained ML model, the set of prompts configured to result in the trained ML model generating an output data targeted structure;
(c) combining the set of prompts into a singular prompt data object; and
(d) applying the singular prompt data object and the multimedia content object to the trained ML model to generate, as an output of the trained ML model, an output data object according to the output data targeted structure.

2. The computer-implemented method of claim 1, wherein the set of prompts comprises a data structure operated upon as a single prompt.

3. The computer-implemented method of claim 2, wherein the data structure includes indications of the output data targeted structure, and wherein the indications indicate that the output data targeted structure should include specific field names, specific data types, specific default values, specific formats, and/or a description of expected content as specified by the indications.

4. The computer-implemented method of claim 2, wherein the data structure includes guidance elements to indicate directions and/or constraints on the output data targeted structure.

5. The computer-implemented method of claim 1, wherein the set of prompts comprises a data structure operated upon as a single prompt that provides an indication of an output schema structure.

6. The computer-implemented method of claim 1, wherein the multimedia content object comprises one or more of text, an image, audio, an animated banner, and/or an interactive webpage.

7. The computer-implemented method of claim 1, wherein the multimedia content object represents an advertisement.

8. The computer-implemented method of claim 1, wherein the multimedia content object is specified by a URL.

9. The computer-implemented method of claim 1, wherein the set of prompts includes a product name prompt, a product type prompt, a genre prompt, and a visual summary prompt.

10. The computer-implemented method of claim 1, wherein the singular prompt data object is formatted as a JSON string.

11. The computer-implemented method of claim 1, wherein the singular prompt data object is formatted in a human-readable form.

12. A computer-implemented method of extracting content from a content object using a multimodal large language model, the method comprising:
receiving an unstructured multimedia content input comprising the content object; and
processing the content object using a single natural language prompt, the single natural language prompt providing, to the multimodal large language model, instructions for extracting structured information from the content object, wherein the structured information is both human-readable and machine-processable.

13. The computer-implemented method of claim 12, wherein the single natural language prompt represents a semantic context of the unstructured multimedia content input.

14. The computer-implemented method of claim 12, wherein the content is video content.

15. The computer-implemented method of claim 12, wherein the multimodal large language model is a model that processes visual content, audio content, and/or textual content.

16. The computer-implemented method of claim 12, wherein the single natural language prompt includes indications of the structured information, and wherein the indications indicate that the structured information should include specific field names, specific data types, specific default values, specific formats, and/or a description of expected content as specified by the indications.

17. The computer-implemented method of claim 16, wherein the indications include guidance elements to indicate directions and/or constraints on the structured information.
